(19) United States
(12) Patent Application Publication
(10) Pub. No.: US 2021/0014696 A1
(43) Pub. Date: Jan. 14, 2021

(54) A DEVICE, METHOD AND COMPUTER PROGRAM PRODUCT FOR RE-ALLOCATING RADIO SPECTRUM

(71) Applicant: Sony Corporation, Tokyo (JP)

(72) Inventor: Karl BROOKES, Southampton (GB)

(73) Assignee: Sony Corporation, Tokyo (JP)

(21) Appl. No.: 16/982,323

(22) PCT Filed: Mar. 15, 2019
(86) PCT No.: PCT/GB2019/050735

§ 371 Date: Sep. 18, 2020

(30) Foreign Application Priority Data
Mar. 28, 2018 (GB) 1805061.7

(51) Int. Cl. H04W 16/14; H04W 72/04; G06F 16/23; G06F 16/29

(52) U.S. Cl. CPC H04W 16/14; G06F 16/29; G06F 16/2379; H04W 72/0453

(57) ABSTRACT

Described is a method of re-allocating frequency bands in an available spectrum, comprising: receiving a first request for allocation of frequency bands via an interface; comparing the request with a plurality of spectrum entitlement records in a publically readable database, the plurality of spectrum entitlement records relating to different frequency bands and between them providing information for the entire available spectrum; re-allocating at least a frequency band of the available spectrum based on the request by identifying available frequency bands from the spectrum entitlement records; adding a spectrum entitlement record to the publically readable database representing the re-allocating of the at least a frequency band of the available spectrum.

### BACKGROUND

### Field of the Disclosure

The present invention relates to a device, method and computer program product for re-allocating radio spectrum.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

Presently, Governments and Regulators decide how radio spectrum (referred to as spectrum from here) is allocated. For example, in the United Kingdom, various different radio frequency (referred to as frequency from here) bands are used to deliver 2G, 3G and 4G mobile services. These bands are typically sold to network providers by Governments for example by issuing a license. Similar schemes apply to the allocation of other frequency bands, for example for broadcast television and radio.

Once allocated to a particular network provider, the network provider is assumed to use the allocated spectrum all of the time for example for the duration of a licensing period. This means other providers are not allowed use the allocated spectrum. However, in reality, the spectrum may not be used all of the time and may only be used during certain periods of the day. Indeed, on occasion, the allocated spectrum may not be used at all by the allocated network provider. This means that spectrum is not efficiently used.

It is an aim of embodiments of the present disclosure to address at least this problem.

### SUMMARY

Embodiments of the present disclosure are provided in the appended claims.

The foregoing paragraphs have been provided by way of general introduction, and are not intended to limit the scope of the following claims. The described embodiments, together with further advantages, will be best understood by reference to the following detailed description taken in conjunction with the accompanying Figures.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows various components of a system according to embodiments of the disclosure;

FIG. 2 shows a device according to embodiments of the disclosure;

FIG. 3 shows a server according to embodiments of the disclosure;

FIG. 4 shows an interface according to embodiments which is used by the entity to whom the spectrum is currently allocated;

FIG. 5 shows a data structure stored in a database within the server according to embodiments;

FIG. 6 shows an interface according to embodiments which is used by the entity who is requesting that spectrum is re-allocated;

FIG. 7 shows a data structure sent from the entity requesting that spectrum is re-allocated;

FIG. 8 shows an updated data structure stored in the database within the server after re-allocation of the spectrum has taken place;

FIG. 9 shows a flow chart describing the process carried out by the device 200 according to embodiments;

FIGS. 10 and 11 show different steps of the flow chart of FIG. 9 in more detail.

### DESCRIPTION OF THE EMBODIMENTS

Referring now to the drawings, wherein like reference numerals designate identical or corresponding parts throughout the several views.

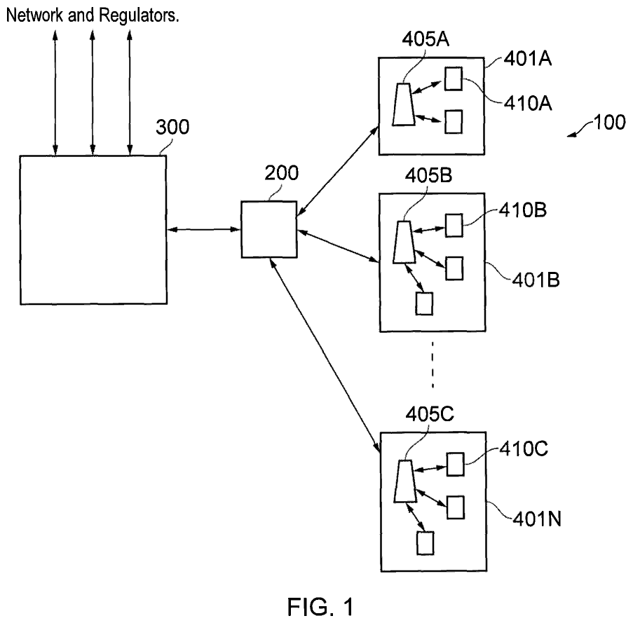

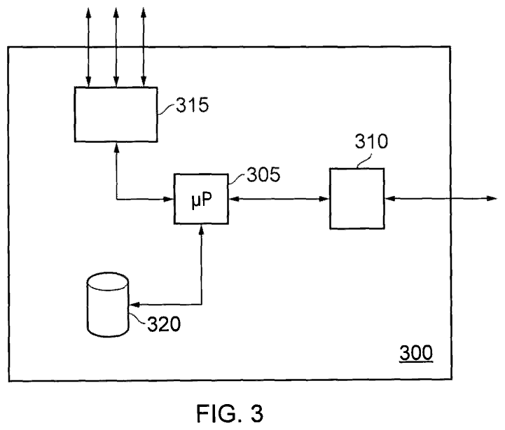

FIG. 1 describes a system 100 according to embodiments of the present disclosure. The system 100 comprises a server 300. Whilst the server 300 will be described with reference to FIG. 3, the purpose of the server 300 is to receive requests for spectrum allocation and re-allocation and to store a publically available database. The server 300 may be a single server based in a location such as data centre or may be distributed over many locations.

The server 300 is connected to network management companies and regulators. This may be over a network such as the Internet. This network may be a private network or may be via a web-server. For example, the server 300 may be connected to companies via a web portal. These companies have been allocated spectrum (the owner described later). In other words, the owner is a person or company to whom that particular spectrum has been allocated, by for example, the regulator. The server 300 is also connected to companies who require spectrum (the purchaser described later) to operate their networks. In particular, the purchaser is a person or company which requires use of the spectrum currently allocated to the owner. Finally, the server 300 is connected to regulators who regulate the use of spectrum in a territory. The purpose of the publically available database is to be a single repository of spectrum allocation that may be viewed by any interested party.

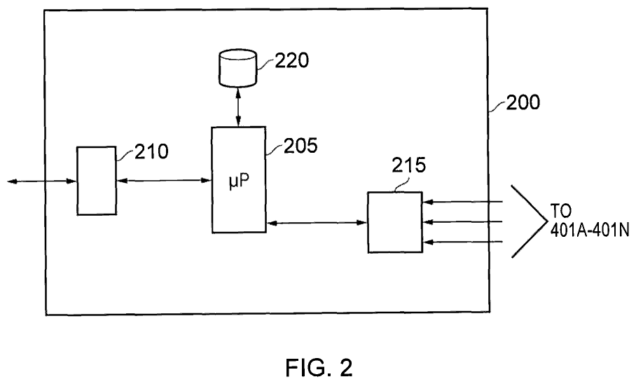

Additionally connected to the server 300 is a device 200 according to embodiments of the disclosure. Although the device 200 will be described in detail with reference to FIG. 2, the device 200 re-allocates the spectrum (which is already allocated to the owner) to a purchaser. The re-allocation may be temporally limited (for example, for a predefined period of time), geographically limited (for example, for a specific location, area or network cell) or a combination of temporal and geographically limited. Of course, the re-allocation may be permanent or be defined in any manner suited to the purchaser and owner.

The device 200 is also configured to receive requests for spectrum re-allocation from purchasers. These requests may be received directly from purchasers or may be received from the purchasers via the server 300. In some embodiments, of course, the device 200 may be part of, or be integral to, the server 300.

The device 200 is also configured to communicate with both the purchaser of the spectrum and the owner of the spectrum to verify the re-allocation of the spectrum. In addition, the device 200 is configured to communicate with the server 300, and specifically, to update the publically available database stored within the server 300. This ensures that the publically available database stored within the server 300 is a single repository of spectrum allocation and use. The entries within the publically available database are immutable. That is, the entries within the database cannot be edited once entered onto the database. In embodiments, a transaction entered in error might be reversed by reallocating the spectrum to the original owner or party which has agreed or acquired previous contractual rights. In some embodiments, the entries within the database are made on so-called spectrum entitlement records. In particular, one entry is made upon a spectrum entitlement record.

The database is shown within the server 300. However, in embodiments, the database may be placed on a blockchain. As would be appreciated, a blockchain is an open and distributed ledger that is used to record transactions between two parties efficiently and in a verifiable way. In this case, each row within the database will be a new block within the chain.

In embodiments a version or part of a version of the blockchain may optionally be stored on server 300 in addition to storage at multiple other servers at different locations. In embodiments server 300 comprises a blockchain client. This may be software running on server processor. In embodiments the blockchain is considered to be a form of database. In embodiments, the received blockchain may be assembled by server control circuitry into a database structure (such as a MySQL or Oracle database) for processing or querying. Querying may be by SQL queries. This database structure may be temporarily stored on a storage medium. It will be appreciated that the blockchain updates periodically for example when a new purchase or transaction is added and a new version may need to be acquired when for example a new query for allocation is made. Embodiments may therefore store the database structure temporarily and erase or otherwise delete it when processing is complete. In non-limiting examples, queries or algorithms configured to generate queries for radio spectrum allocation may be pre-stored outside of the database structure and/or may be incorporated into the database structure when it is assembled by the processor.

Additionally, the device 200 is connected to one or more network nodes 401A-401N. Each network node 401A-401N operates across a frequency band(s) and may be, for example, a cognitive radio system. Although a cognitive radio system adapts its transmission parameters depending on the conditions, many types of cognitive radio system are allocated spectrum to operate. Additionally, a cognitive radio system may be temporarily used in a particular geographical location. For example, during a large concert or other public gathering, cognitive radio systems are used to transmit audio data across the gathering. This means that cognitive radio systems may temporarily require spectrum which may be limited to a particular geographical area. The network nodes such as 401A may operate with different physical layer protocols for example ATSC3.0 and Wi-Fi or Wimax. In embodiments, one network node may operate with multiple physical layer protocols, for example switching from one to another as required.

A cognitive radio system 401A will include infrastructure 405A in communication with terminal devices 410A. The infrastructure 405A will be allocated a frequency range(s) or channel by the device 200. In other words, in embodiments, the infrastructure 405A communicates with the terminal devices 410A in the network node 401A using the frequency that has been allocated by the device 200. The network node 401A may be able to monitor the radio spectrum at its location and on this basis request specific and optimal frequency range(s) or channel for the service or application it is running The network node 401A is operated by a company who is a purchaser of the spectrum and the spectrum used in the network node 401A is re-allocated from the owner of the spectrum.

FIG. 2 shows a device 200 according to embodiments of the disclosure. The device 200 comprises device control circuitry 205 connected to device/infrastructure communications circuitry 215. In embodiments, the device/infrastructure communications circuitry 215 is configured to communicate with the infrastructure located within the network nodes 401A-401N under the control of the device control circuitry 205.

This communication may occur over a point-to-point link or a network connection. The network connection may be a local network, or a private network, or a virtual private network or the like.

The device control circuitry 205 is a processor that operates under the control of computer software. For example, the device control circuitry 205 is a microprocessor that operates under the control of software stored within device storage 220 that is connected to the device control circuitry 205. The device control circuitry 205 may therefore be constructed from semiconductor material and may be embodied as a microprocessor. Device storage 220 therefore, in embodiments, contains computer readable software that configures the device control circuitry 205 to perform certain methods within the embodiments of the disclosure.

In addition, server/infrastructure communications circuitry 210 is connected to the device control circuitry 205. In embodiments, the server/infrastructure communications circuitry 210 is configured to communicate with the server 300 under the control of the device control circuitry 205. This communication may occur over a point-to-point link or a network connection. The network connection may be a local network, or a private network, or a virtual private network or the like.

FIG. 3 shows the server 300 according to embodiments of the disclosure. The server 300 comprises server control circuitry 305 connected to server/device communications circuitry 310. In embodiments, the server/device communications circuitry 310 is configured to communicate with the device 200 under the control of the device control circuitry 205.

This communication may occur over a point-to-point link or a network connection. The network connection may be a local network, or a private network, or a virtual private network or the like.

The server control circuitry 305 is a processor that operates under the control of computer software. For example, the server control circuitry 305 is a microprocessor that operates under the control of software stored within server storage 320 that is connected to the server control circuitry 305. The server control circuitry 305 may therefore be constructed from semiconductor material and may be embodied as a microprocessor. Server storage 320 therefore, in embodiments, contains computer readable software that configures the server control circuitry 305 to perform certain methods within the embodiments of the disclosure.

In addition, server/user communications circuitry 315 is connected to the server control circuitry 305. In embodiments, the server/user communications circuitry 315 is configured to communicate with the owner/purchaser and regulator under the control of the server control circuitry 305. This communication may occur over a point-to-point link or a network connection. The network connection may be a local network, or a private network, or a virtual private network or the like.

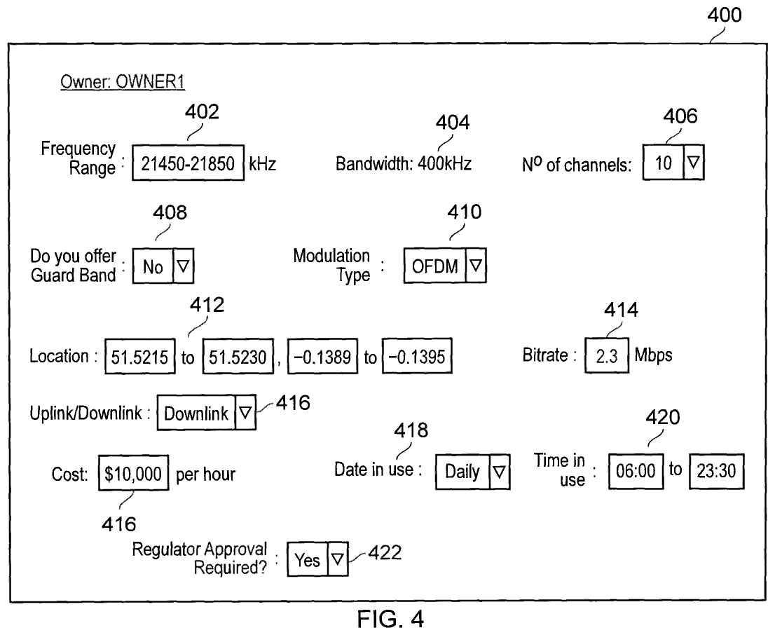

FIG. 4 shows an interface 400 used by a company which has already been allocated spectrum. This may be by the acquisition or granting of a license from a government or regulatory body. The interface 400 is completed by an owner of the spectrum using the terminology defined above and submitted to the device 200. In particular, the interface is completed by “Owner1”. The interface 400 is used by Owner1 to identify the spectrum which has been allocated to it. Owner1 may identify all spectrum which has been allocated to it or only spectrum that is available for re-allocation to a purchaser. This disclosure is not limited to the above.

The purpose of the interface 400 is to provide enough relevant information for a purchaser and/or regulator to determine whether the frequency range(s) or channel(s) may be re-allocated. Within the interface are a number of fields to be completed. These fields define the information which will be used to determine whether the spectrum may be re-allocated. Accordingly, although the interface of FIG. 4 shows numerous information fields, the disclosure is in no way limited to this information. It may for example include frequencies of notches in the frequency range that cannot be used. It may for example include a maximum power of transmission. Different mechanisms for providing the information and different information are all within the scope of this disclosure.

The first field 402 defines the frequency range of the spectrum available to be re-allocated. The second field 404 is the bandwidth of the available in the frequency range to be re-allocated. The third field 406 defines the number of channels within the defined frequency range.

The fourth field 408 defines whether a guard band is provided. In this case, owner1 has stated that no guard band is provided. In the event that owner 1 selected “yes”, a further field may be provided allowing owner1 to define the amount of guard band. The amount of guard band may be in Hz or for example in a number of samples of a particular transmission protocol. The fifth field 410 defines the modulation type associated with the frequency range.

The sixth field 412 defines a location over which the frequency range is available for re-allocation. For example, owner1 may wish to restrict the geographical location for which the frequency range is available for re-allocation. Although the geographical location is shown as a range of co-ordinates (so-called GPS Co-ordinates), the disclosure is not so limited. For example, the geographical location could be a specific co-ordinate with a radius of coverage. Alternatively, or additionally, the geographical location may be a specific cell identifier that defines a particular telecommunications cell in a cellular network.

The seventh field 414 defines a bitrate that is used in the frequency range available for re-allocation. The eighth field 416 defines whether any uplink and/or downlink channels are being made available for re-allocation.

The ninth field 416 defines the value attributed by Owner1 to the frequency range available for re-allocation. In the specific example of FIG. 4, this value has been set at an hourly rate. Of course, the disclosure is not so limited. For example, the value may be set for a predetermined period of time. Another option may be to mark the value as “open to offers”. In other words, owner1 does not define a particular value, but rather waits for purchasers to provide offers to re-allocate the spectrum. The time to provide offers may be limited and this may be defined in the interface.

The tenth field 418 defines the date in which the allocated spectrum is used. In the case of FIG. 4, this is defined as “daily”. Of course, a particular day or date range may be inserted in this field. This may be provided by a drop-down calendar for convenience. Although the tenth field 418 defines the date in which the allocated spectrum is used, instead the tenth field 418 may define the date in which the allocated spectrum is not used.

The eleventh field 420 defines a time range in which the allocated spectrum is used. This may be provided by a drop-down clock for convenience. Although the eleventh field 420 defines the time range in which the allocated spectrum is used, instead the eleventh field 420 may define the time range in which the allocated spectrum is not used.

The purpose of the tenth field 418 and the eleventh field 420 is to define a temporal period for which the spectrum may be re-allocated.

The twelfth field 422 defines whether regulatory approval is required for the re-allocation to be allowed. In the event that regulatory approval is required, the regulator is notified when owner1 submits the completed fields to the device 200. The regulator may be notified over the internet or another network. In this case, the regulator may need to approve the re-allocation before the re-allocation is permitted. In embodiments, this may be a positive approval by the regulator or may be an implicit approval if, for example, no rejection of the re-allocation is made within a predefined period of for example 48 hours.

It should be noted that one or more of the fields may be automatically completed based upon the information provided in other fields. For example, the second field 404 may be automatically completed based upon the frequency range entered in the first field. Specifically, the value in the second field 404 is the difference between the frequencies entered in the first field.

As another example, the fields may be automatically completed by using the information provided in one field and referring to a regulator. That is, in a non-limiting manner, the regulator may have allocated the frequency range entered in the first field as being split into 10 channels. Therefore, in this case, the frequency range entered in the first field may be used to interrogate a database maintained by the regulator to extract relevant information about the frequency range. In this case, the third field may be thus autocompleted to show 10 channels.

This automatic completion of fields reduces the burden on the user and the risk of errors in entering the data into the relevant fields within the interface 400.

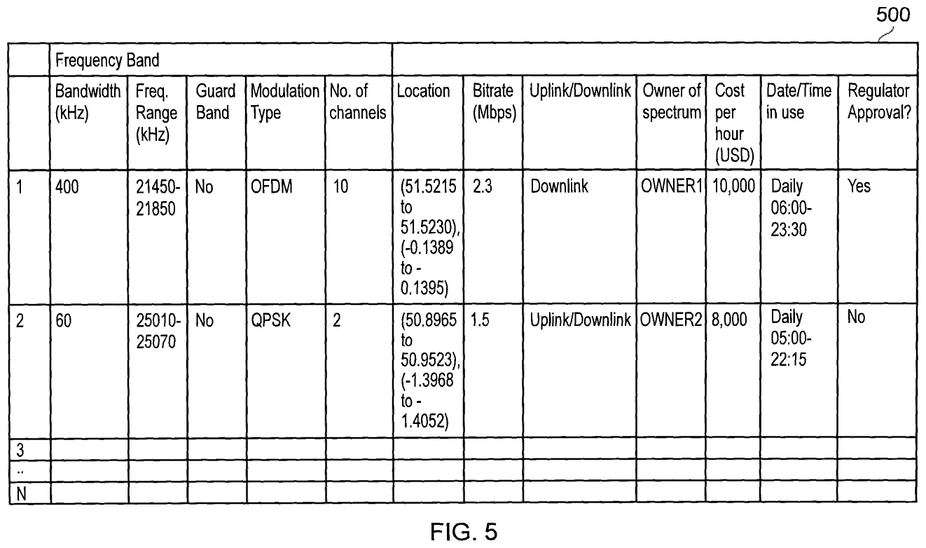

FIG. 5 shows an example of a publically available database stored on the server 300. Specifically, a data structure 500 is shown in FIG. 5 that constitutes one example of the publically available database. As will be evident, the first to twelfth fields defined in the interface 400 of FIG. 4 are provided in the data structure 500 of FIG. 5. In the particular example of FIG. 4, the information entered in the interface 400 of Figure is provided as row “1” of the data structure 500.

For ease of reference, a second row (row “2”) is shown. Row “2” is provided by a second owner (owner2).

As noted above, although the two rows are provided on data structure 500 that is publically available, the data structures are immutable which means that the data structures cannot be edited once entered into the data structure 500.

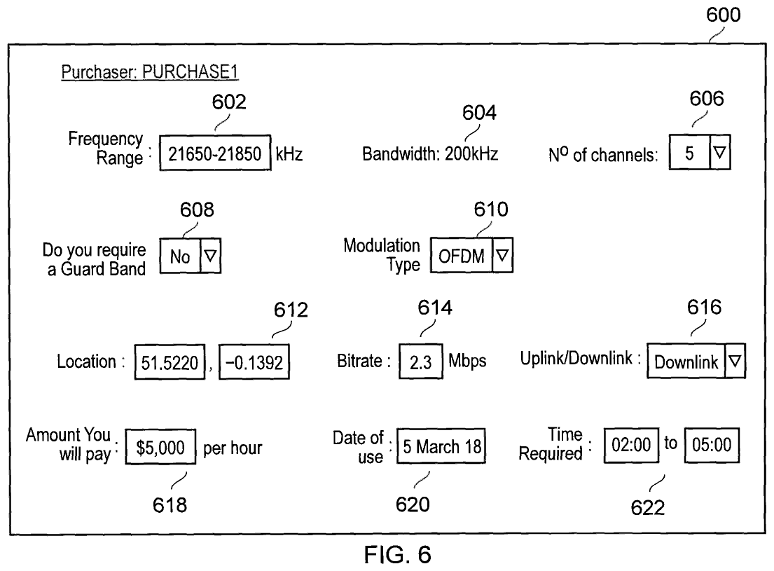

FIG. 6 shows an interface 600 used by a purchaser of the allocated spectrum. In other words, the interface 600 is completed by a purchaser of the allocated spectrum using the terminology defined above and submitted by the purchaser to the device 200.

In particular, the interface is completed by “Purchase1”. The interface 500 is used by Purchase1 to identify spectrum which it wishes to be re-allocated. For example, Purchase1 may have a requirement for licensed spectrum during a public event such as a concert. This means that Purchase1 requires re-allocated spectrum which is limited to a specific geographical location for a specific period of time. However, as will be appreciated, the disclosure is not limited.

Similarly to FIG. 4, the purpose of the interface 600 is to provide enough relevant information for an owner and/or regulator to determine whether spectrum may be re-allocated. Within the interface are a number of fields to be completed. These fields define the information which will be used to determine whether the spectrum may be re-allocated. Accordingly, and like FIG. 4, although the interface of FIG. 6 shows numerous information fields, the disclosure is in no way limited to this information. Different mechanisms for providing the information and different information are all within the scope of this disclosure.

The first field 602 defines the frequency range of the spectrum desired to be re-allocated. The second field 604 is the bandwidth of the spectrum available to be re-allocated. The third field 606 defines the number of channels within the defined frequency range that is desired.

The fourth field 608 defines whether a guard band should be provided. In this case, purchase1 has stated that no guard band is provided. In the event that purchase1 selected “yes”, a further field may be provided allowing purchase1 to define the amount of guard band desired. The amount of guard band may be in Hz or for example in a number of samples of a particular transmission protocol. The fifth field 610 defines the modulation type associated with the spectrum which is desired.

The sixth field 612 defines a location over which the spectrum is to be re-allocated. For example, purchase1 wishes to restrict the geographical location for which the spectrum will be re-allocated. In the example, the geographical location is a specific co-ordinate. Alternatively, or additionally, the geographical location may be a specific cell identifier that defines a particular telecommunications cell in a cellular network.

The seventh field 614 defines a bitrate that will be used on the desired spectrum. The eighth field 616 defines whether any uplink and/or downlink channels are required for re-allocation.

The ninth field 618 defines the value that purchase1 is willing to pay for the spectrum to be re-allocated. In the specific example of FIG. 6, this value has been set at an hourly rate. Of course, the disclosure is not so limited. For example, and similar to FIG. 4, the value may be set for a predetermined period of time. Another option may be to mark the value as “negotiable”. In other words, purchase1 does not define a particular value, but rather enters into negotiation with an owner to re-allocate the spectrum.

The tenth field 620 defines the date in which the allocated spectrum is required. In the case of FIG. 6, this is defined as “5 Mar. 2018”. Of course, a particular date range may be inserted in this field. This may be provided by a drop-down item representing a calendar for convenience.

The eleventh field 622 defines a time range in which the allocated spectrum is required. This may be provided by a drop-down item representing a clock for convenience.

The purpose of the tenth field 620 and the eleventh field 622 is to define a temporal period for which the spectrum is desired to be re-allocated.

Similarly to FIG. 4, it should be noted that one or more of the fields may be automatically completed based upon the information provided in other fields. For example, the second field 604 may be automatically completed based upon the frequency range entered in the first field. Specifically, the value in the second field 604 is the difference between the frequencies entered in the first field.

As another example, the fields may be automatically completed by using the information provided in one field and referring to a regulator. That is, in a non-limiting manner, the regulator may have allocated the frequency range entered in the first field as being split into 5 channels. Therefore, in this case, the frequency range entered in the first field may be used to interrogate a database maintained by the regulator to extract relevant information about the frequency range. In this case, the third field may be thus autocompleted to show 5 channels.

This automatic completion of fields reduces the burden on the user and the risk of errors in entering the data into the relevant fields within the interface 600.

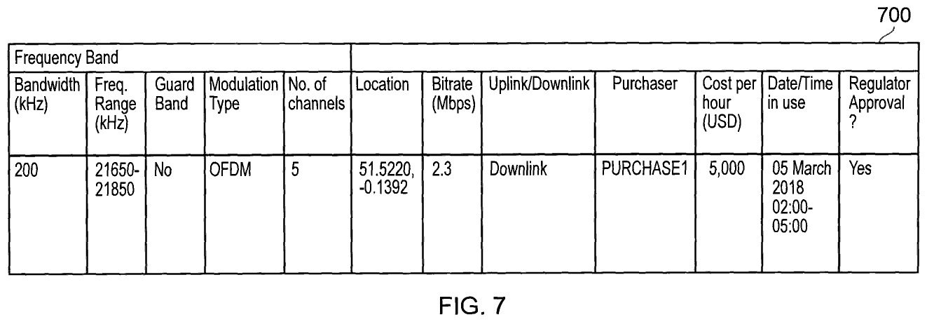

FIG. 7 shows a non-limiting embodiment of a request provided by purchase1 to re-allocate spectrum. In particular, a request 700 is a data structure generated by purchase1 from the information provided in interface 600. The request contains information enabling device 200 to determine whether the spectrum may be re-allocated to purchase1. The request is sent to device 200.

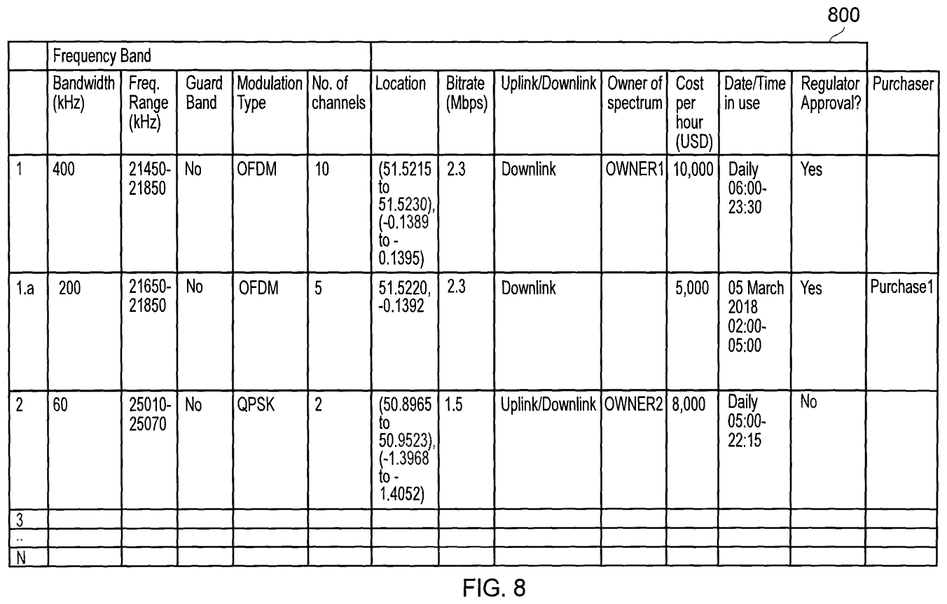

FIG. 8 shows a non-limiting embodiment showing the publically available database 800 after the request for re-allocation of spectrum has been verified and approved by device 200. As will be evident, the request that has been verified has been inserted into the publically available database in row 1.a. That is, the verified request is stored in association with the spectrum available for re-allocation.

As will also be evident, the verified request has reduced the availability of the spectrum in row 1 as this has now been re-allocated to purchase1. However, the entry in row 1 has not been altered or edited and is immutable. Instead, the verified request has been inserted into the publically available database. Moreover, it is envisaged that any agreement between owner1 and purchase1 will be stored in association with the verified request in row 1.a. Similarly, any approval from a regulatory body will be stored in association with the verified request. The location of row 1a in the database is merely indicative. It could be stored in a related table and related to the illustrated row 1 by an identifier. It will be appreciated that the device 200 should in embodiments be able to interpret the latest entry related to a particular part of the spectrum at a particular time in order to select an appropriate slot in response to a purchase request. In embodiments an entry in the database may include a time field or timestamp to identify the latest records. It may be that one request wholly supersedes another or partially supersedes another. Of course as can be seen from FIG. 8, purchases of spectrum can still be made relating to the entry in row 1 for example for frequency range 21450-21650 kHz at the same time (5 Mar. 2008 02:00-05:00) as the request in row 1a.

It will also be appreciated that although the spectrum detailed in Row 1a is subject to purchase, the purchaser may be prepared to have his purchase re-allocated. Accordingly, in embodiments, the spectrum detailed in Row 1a may be selected in response to a purchase request. As such a field may indicate that the spectrum in Row 1a should be offered for re-allocation. For example the purchaser may accept a higher amount for further re-allocating the spectrum in Row 1a. After the initial purchase the purchaser may not require the re-allocated spectrum so may indicate in a field that the re-allocated spectrum is again available for re-allocation. In other words, the purchaser may re-allocate the already re-allocated spectrum.

As such the blockchain may be updated if a decision is taken to allow re-allocation of the spectrum in row 1a. It may be that a contract is in place that Owner_1 will not accept to refund any payment if the spectrum is re-allocated back to Owner 1 by the purchaser in purchase 1a. In embodiments, the transaction of purchase 1 could be reversed back to owner_1 conditionally on finding a further acquirer, so acquirer would still pay 5000USD per hour or some other sum to owner 1 if no other party requests and purchases that bandwidth.

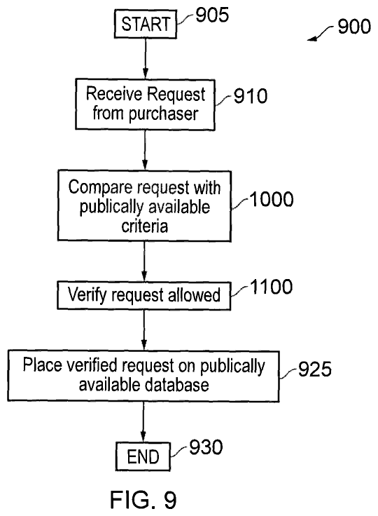

FIG. 9 shows a flow diagram explaining a process 900 carried out by device 200. The process 900 starts at step 905. The process then moves to step 910 where a request for re-allocation of the spectrum is received from the purchaser. This request is shown in, and described with reference to, FIG. 6. This request may be received directly from the purchaser or may be received via the server 300. In other words, the purchaser may send the request to the server 300 and the server 300 may send the request to the device 200.

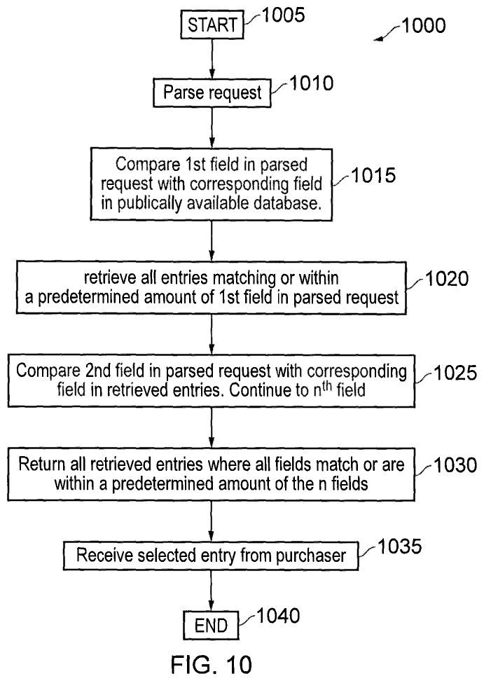

The process moves to step 1000 where the device 200 compares the received request with the publically available database. In other words, the device 200 compares the received request with the data structure 800 stored on the publically available database. This comparison step is described in FIG. 10.

During the comparison step, the device 200 selects one or more appropriate spectrum entries within the data structure 800. In embodiments, the device 200 selects the most appropriate spectrum entry; that is, the spectrum available for re-allocation that most closely matches the request from purchase1.

Of course, the disclosure is not so limited and the device 200 may select more than one spectrum entry, which is a subset of the entire data structure 800. In this case, the spectrum entries may be sent to purchase1 for purchase1 to select its preferred spectrum entry from the subset.

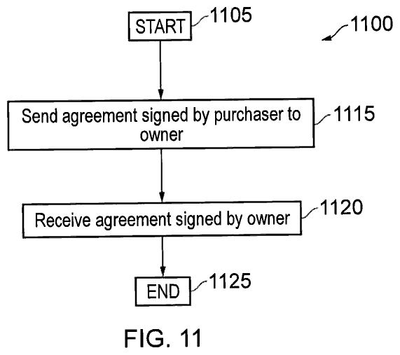

After a request has been selected in step 1000, the process moves to step 1100. In this step, the request is verified and allowed. This is described with reference to FIG. 11.

The process then moves to step 925 where the verified request is placed by the device 200 on the publically available database as shown in FIG. 8. The details of the re-allocated spectrum are then passed to the network nodes 401A-401N.

The process then ends at step 930.

FIG. 10 shows a flow diagram explaining step 1000 in more detail.

The process 1000 starts at step 1005. The process then moves to step 1010 where the request issued by purchase1 is parsed. In other words, the information entered in interface 600 is extracted and associated with a corresponding field in the database. This means that purchase1 need not use interface 600 and may provide the information in any form. For example, the request from purchase1 may be a document, spreadsheet or the like. In the event that the request from purchase1 is not in a standardised form (that is, the information is provided in a free-text format), then the parsing in step 1010 includes keyword identification. For example, the parsing step will review the non-standardised request and identify keywords such as “Hz” or “Hertz” as the numbers preceding this will indicate a frequency. Other keywords such as “range” will be identified, especially if placed near “Hz” as this will indicate a frequency range. For example, if the request includes the phrase “range is 21650-21850 kHz”, the parsing step will identify “range” and “21650-21850 kHz” and will interpret this to mean the field “frequency range” is “21650-21850 kHz”. Machine learning may be implemented to improve the accuracy of the parsing in the free-form request.

After the request has been parsed in step 1010 and the information extracted and associated with a corresponding field in the publically available database, the process then moves to step 1015.

In step 1015 the content of the first field in the parsed request is compared with the corresponding field in the publically available database. In other words, the value of the first field is compared with the corresponding field in the database. So, in the example of FIG. 5, the value of the frequency range field in the request is compared with the frequency range field in the database.

The process then moves to step 1020 where the device 200 retrieves all of the entries from the publically available database that match, are within a pre-determined amount of the entry in the first field of the request, or overlap the value entry in the first field of the request. In some instances, the pre-determined amount may be a percentage of the requested value or may be a defined numeric value. Indeed, the predetermined amount may be different depending upon a priority attributed to the field. The priority may be attributed by purchase1 or may be automatically attributed based upon technical constraints. For example, the priority associated with the location may be high compared with the number of channels required. This is because purchase1 wishes to use the re-allocated spectrum in a public event taking place at a particular location.

It is possible that the first field is the field having the highest priority. This ensures that the most relevant results are considered and returned to purchase1 as will become apparent.

The reason for retrieving all of the entries is to reduce the number of entries subjected to further analysis. This reduces the processor burden on the device processing circuitry 205.

The process then moves to step 1025 where the device 200 compares the value of the second field in the request with the corresponding field in the retrieved entries.

In this case, those entries that match, are within a pre-determined amount of the entry in the first field of the request or overlap the value entry in the first field of the request are kept; the remainder are ignored. This process continues for all of the fields in the request. In other words, the process continues for all of the N fields in the request.

The process then moves to step 1030 where the retrieved entries that remain at the end of the comparison step are returned to purchase1.

In the event that there are no entries remaining, the entry or entries that were the last to be ignored are returned to purchase1. In other words, the entries that most closely match the request are returned. Of course, purchase1 may indicate that only entries exactly matching their request are returned. In this case, a message is returned to purchase1 indicating that no matches have been found.

In addition to returning the retrieved entry or entries to purchase1, an agreement is returned to purchase1. This agreement identifies the information in the returned entry or entries. For example, the agreement identifies the frequency range, cost, time period, geographic location and the like noted in each entry.

Purchase1 then confirms that they wish to purchase the spectrum associated with the entry or entries identified in the agreement. In embodiments, this confirmation requires purchase1 to sign the agreement electronically. The signed confirmation is then sent to device 200 which receives the confirmation. This is step 1035.

The process then ends in step 1040.

FIG. 11 shows the process of step 1100 in more detail.

The process 1100 starts at step 1105.

The process then moves to step 1115. In step 1115, the signed agreement is sent to the owner. In other words, the agreement signed by purchase1 is sent to owner1. Owner1 then countersigns the agreement to confirm that owner1 wishes for the spectrum to be reallocated to purchase1 under the terms and conditions set out in the agreement. The countersigned agreement is then sent to device 200 by owner1. This is step 1120.

The process then ends at step 1125.

In the event that a regulator needs to approve the transaction, the countersigned agreement may be sent to the regulatory body after step 1120. The regulatory body may then apply its countersignature to the agreement signed by both the owner and purchaser of the spectrum for re-allocation. The regulator may then return the countersigned agreement to the device 200.

As noted above, it is possible that the cost for re-allocation of the spectrum is determined by auction. In this case, the request received from purchase1 may include a maximum bid for the spectrum. In addition, the owner of the spectrum (i.e. the entity to which the spectrum is allocated) may set a reserve price which is the minimum amount of money that they would accept for the spectrum. At the allotted time, the device 200 will check all the maximum bids received from the prospective purchasers and will re-allocate the spectrum to the highest bidder. In this case, the device 200 will send a new agreement to the purchaser to sign and return to the device 200. This agreement will then be sent to the owner in step 1115 to countersign and the process of FIG. 11 will continue.

In the above, one database is described containing all the transactions in a territory. It should be noted that the disclosure is not so limited. In some instances, one database may be provided for each cell within a cellular network. In other instances, one database may be provided for a frequency range across all of the territory.

Other requirements that may be provided by the owner and/or purchaser of the spectrum include:

a) Transmitter maximum/minimum output power

b) Transmitter spectrum emission mask

c) Transmitter Spurious emissions

d) Listen Before Talk

e) Automatic Power Control

f) Duty Cycle

g) Dynamic Frequency Selection

h) Sensing

i) Receiver performance requirements, e.g. sensitivity, blocking, adjacent channel selectivity, intermodulation characteristics,

j) Pairing of frequency bands to provide additional efficiency and/or coverage improvement

k) Partial bandwidth may only be required. In this case, the purchaser could join a statistical multiplex with other customers

l) Usage, Radio Services as defined by ITU-R Radio Regulations Chapter 1 Section III—Radio services e.g. Broadcast Service (DVB, ATSC3.0), Mobile (2G/3G/4G (LTE Evolutions)/5G, NB IoT, LTE-M), fixed Service, fixed-satellite service, and WiMAX, LPWAN, or any other physical layer protocol

m) Other Rules: For example the purchaser will move dynamically to another frequency band if the space is needed for some higher priority use. This may be accepted upon payment of a subsidy or fee. Additionally or alternatively, the customer has signalling capabilities that enable receivers to re-tune automatically. Additionally or alternatively, interference mitigation may be provided by the purchaser to allow other users to operate on the same, similar or adjacent frequencies to that being re-allocated. This would allow the owner to re-allocate the frequency to another purchaser. Further details of how the payment is split between government fees and owner fees may be provided.

Additionally, it is possible that the network nodes notify the device 200 when purchaser1 has used the re-allocated spectrum. This may be used to provide a new row associated with re-allocation information.

By having the spectrum and the re-allocated spectrum on a publically available database, third parties such as electronic program guide providers may use the database to generate program guides automatically or partially automatically. This may be by software operating on computers which request specific program information from purchasers related to re-allocations of spectrum for given time and frequency slots, or for example by having specific program information pushed to the provider's server interface circuitry.

The cost of the re-allocation may vary over time. For example, where the spectrum may be re-allocated at a particular date and/or time, the cost may decrease the closer to the particular date/time it becomes.

It may also be appropriate to ensure that a period of time is provided between the re-allocation being placed on the publically available database and the actual re-allocation taking place. This will allow a period of time for third parties to object to the re-allocation.

In embodiments nodes 401A-401N may decode the blockchain and use the information in the purchase to control transmissions or to fetch data for transmission from a purchaser's server. For example, from the blockchain the node 401A or a controlling circuitry connected to it may cease a particular transmission from a first purchaser at a time and frequency detailed in the blockchain. It may start a transmission from a second purchaser at that time and frequency for example if there were a purchase in FIG. 8 that used the same parameters as row 1a, but running from 05:00-08:00 on 5 Mar. 2018. Accordingly, embodiments of the disclosure relate to transmission scheduler circuitry which decode scheduling information from a blockchain and change transmissions according to purchases represented in the blockchain. Further embodiments relate to a receiver which comprises circuitry which decodes the blockchain in order to understand when it power up and/or tune its receiver circuitry to a particular frequency or frequency band. In yet further embodiments, the circuitry which decodes the blockchain is located remotely to the receiver and the receiver receives from it instructions as to when to power up and/or tune to a particular frequency or frequency band. This may reduce the requirement for processing capabilities of the circuitry of the receiver, potentially reducing receiver cost.

Although the above discusses a user providing the request, the disclosure is not limited and any entity using an interface may provide the request.

Obviously, numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Various embodiments of the disclosure are defined in the following numbered clauses

1. A method of re-allocating frequency bands in an available spectrum, comprising:

receiving a first request for allocation of frequency bands via an interface;

comparing the request with a plurality of spectrum entitlement records in a publically readable database,

the plurality of spectrum entitlement records relating to different frequency bands and between them providing information for the entire available spectrum;

re-allocating at least a frequency band of the available spectrum based on the request by identifying available frequency bands from the spectrum entitlement records;

adding a spectrum entitlement record to the publically readable database representing the re-allocating of the at least a frequency band of the available spectrum.

2. A method according to clause 1, wherein the added spectrum entitlement record relates to only part of a frequency band to which another spectrum entitlement record relates.

3. A method according to clause 1, wherein the added spectrum entitlement record relates to the frequency band to which another spectrum entitlement record relates and further relating to a time allocation for the frequency band.

4. A method according to clause 1, wherein the added spectrum entitlement record relates to only a first part of a frequency band to which another spectrum entitlement record relates and the method further comprises adding, in response to a further request, a further spectrum entitlement record which relates to only a second part of the frequency band.

5. A method according to clause 1, wherein the spectrum entitlement record is immutable.

6. A method of re-allocating radio spectrum, comprising:

receiving a request for allocation of radio spectrum via an interface;

comparing the request with a publically readable database of available spectrum;

re-allocating at least part of the available spectrum based on the request; and

updating the publically readable database according to the re-allocated spectrum.

7. A method according to clause 6, wherein the publically readable database is a blockchain.

8. A method according to clause 6, comprising: sending a selected available spectrum to the first user and receiving in response an agreement, signed by the first user, wherein the spectrum is re-allocated based on the signed agreement.

9. A method according to clause 6, wherein the updating step comprises storing an immutable version of the request on the publically readable database.

10. A method according to clause 6, wherein the request comprises: the radio frequency of the spectrum to be re-allocated and an indication of price which the first user will pay for re-allocation of the spectrum.

11. A method according to clause 10, wherein the price is determined by auction.

12. A method according to clause 6, wherein the request comprises a geographical location at which re-allocation of the spectrum will occur.

13. A computer program product comprising computer readable instructions which, when loaded onto a computer, configures the computer to perform a method according to clause 1.

14. A device for re-allocating frequency bands in an available spectrum, comprising processing circuitry configured to:

receive a first request for allocation of frequency bands via an interface;

compare the request with a plurality of spectrum entitlement records in a publically readable database, the plurality of spectrum entitlement records relating to different frequency bands and between them providing information for the entire available spectrum;

re-allocate at least a frequency band of the available spectrum based on the request by identifying available frequency bands from the spectrum entitlement records;

add a spectrum entitlement record to the publically readable database representing the re-allocating of the at least a frequency band of the available spectrum.

15. A device according to clause 14, wherein the added spectrum entitlement record relates to only part of a frequency band to which another spectrum entitlement record relates.

16. A device according to clause 14, wherein the added spectrum entitlement record relates to the frequency band to which another spectrum entitlement record relates and further relating to a time allocation for the frequency band.

17. A device according to clause 14, wherein the added spectrum entitlement record relates to only a first part of a frequency band to which another spectrum entitlement record relates and the processing circuitry is further configured to add, in response to a further request, a further spectrum entitlement record which relates to only a second part of the frequency band.

18. A device according to clause 14, wherein the spectrum entitlement record is immutable.

19. A device for re-allocating radio spectrum, comprising processing circuitry configured to:

receive a request for allocation of radio spectrum via an interface;

compare the request with a publically readable database of available spectrum;

re-allocate at least part of the available spectrum based on the request; and

update the publically readable database according to the re-allocated spectrum.

20. A device according to clause 19, wherein the publically readable database is a blockchain.

21. A device according to clause 19, wherein the processing circuitry is configured to: send a selected available spectrum to the first user and receiving in response an agreement, signed by the first user, wherein the spectrum is re-allocated based on the signed agreement.

22. A device according to clause 19, wherein the updating step comprises storing an immutable version of the request on the publically readable database.

23. A device according to clause 19, wherein the request comprises: the radio frequency of the spectrum to be re-allocated and an indication of price which the first user will pay for re-allocation of the spectrum.

24. A device according to clause 23, wherein the price is determined by auction.

25. A device according to clause 19, wherein the request comprises a geographical location at which re-allocation of the spectrum will occur.

1. A method of re-allocating frequency bands in an available spectrum, comprising:
receiving a first request for allocation of frequency bands via an interface;
comparing the request with a plurality of spectrum entitlement records in a publicly readable database, the plurality of spectrum entitlement records relating to different frequency bands and between them providing information for the entire available spectrum;
re-allocating, by circuitry, at least a frequency band of the available spectrum based on the request by identifying available frequency bands from the spectrum entitlement records;
adding a spectrum entitlement record to the publicly readable database representing the re-allocating of the at least a frequency band of the available spectrum.

2. The method according to claim 1, wherein the added spectrum entitlement record relates to only part of a frequency band to which another spectrum entitlement record relates.

3. The method according to claim 1, wherein the added spectrum entitlement record relates to the frequency band to which another spectrum entitlement record relates and further relating to a time allocation for the frequency band.

4. The method according to claim 1, wherein the added spectrum entitlement record relates to only a first part of a frequency band to which another spectrum entitlement record relates and the method further comprises adding, in response to a further request, a further spectrum entitlement record which relates to only a second part of the frequency band.

5. The method according to claim 1, wherein the spectrum entitlement record is immutable and the publicly readable database is a blockchain.

6-12. (canceled)

13. A non-transitory storage medium comprising computer readable instructions which, when loaded onto a computer, configures the computer to perform a method according to claim 1.

14. A device for re-allocating frequency bands in an available spectrum, comprising processing circuitry configured to:
receive a first request for allocation of frequency bands via an interface;
compare the request with a plurality of spectrum entitlement records in a publicly readable database, the plurality of spectrum entitlement records relating to different frequency bands and between them providing information for the entire available spectrum;
re-allocate at least a frequency band of the available spectrum based on the request by identifying available frequency bands from the spectrum entitlement records;
add a spectrum entitlement record to the publicly readable database representing the re-allocating of the at least a frequency band of the available spectrum.

15. The device according to claim 14, wherein the added spectrum entitlement record relates to only part of a frequency band to which another spectrum entitlement record relates.

16. The device according to claim 14, wherein the added spectrum entitlement record relates to the frequency band to which another spectrum entitlement record relates and further relating to a time allocation for the frequency band.

17. The device according to claim 14, wherein the added spectrum entitlement record relates to only a first part of a frequency band to which another spectrum entitlement record relates and the processing circuitry is further configured to add, in response to a further request, a further spectrum entitlement record which relates to only a second part of the frequency band.

18. The device according to claim 14, wherein the spectrum entitlement record is immutable.

19. A device for re-allocating radio spectrum, comprising processing circuitry configured to:
receive a request for allocation of radio spectrum via an interface;
compare the request with a publicly readable database of available spectrum;
re-allocate at least part of the available spectrum based on the request; and
update the publicly readable database according to the re-allocated spectrum.

20. The device according to claim 19, wherein the publicly readable database is a blockchain.

21. The device according to claim 20, wherein the processing circuitry is configured to: send a selected available spectrum to the first user and receiving in response an agreement, signed by the first user, wherein the spectrum is re-allocated based on the signed agreement.

22. The device according to claim 20, wherein the updating step comprises storing an immutable version of the request on the publicly readable database.

23. The device according to claim 20, wherein the request comprises: the radio frequency of the spectrum to be re-allocated and an indication of price which the first user will pay for re-allocation of the spectrum.

24. The device according to claim 23, wherein the price is determined by auction.

25. The device according to claim 20, wherein the request comprises a geographical location at which re-allocation of the spectrum will occur.
